(19) United States
(12) Patent Application Publication
(10) Pub. No.: US 2022/0134308 A1
(43) Pub. Date: May 5, 2022

(54) BODY COMPRISING A FUNCTIONAL LAYER INCLUDING METAL ORGANIC FRAMEWORKS AND METHOD OF MAKING THE BODY

(71) Applicant: SAINT-GOBAIN CERAMICS & PLASTICS, INC., Worcester, MA (US)

(72) Inventors: Ian KIDD, Worcester, MA (US); Wesley S. TOWLE, North Grosvenordale, CT (US); Paul W. REHRIG, Sterling, MA (US); Mark HAMPDEN-SMITH, Chelmsford, MA (US)

(21) Appl. No.: 17/453,644

(22) Filed: Nov. 4, 2021

Related U.S. Application Data
(60) Provisional application No. 63/109,813, filed on Nov. 4, 2020.

(51) Int. Cl. B01J 20/22; C01B 37/00; C07F 5/06; C07F 15/02; C23C 2/04

(52) U.S. Cl. CPC B01J 20/226; C01B 37/00; C23C 2/04; C07F 15/02; C07F 5/06

(57) ABSTRACT

A body can comprise a substrate and a functional layer overlying at least a portion of a surface of the substrate. The functional layer can comprise metal organic frameworks (MOFs) and a binder, the binder including an organic polymer, and an adhesion loss factor (ALF) of the functional layer to the substrate can be not greater than 7%.

### CROSS-REFERENCE TO RELATED APPLICATION

This application claims priority under 35 U.S.C. § 119(e) to U.S. Provisional Patent Application No. 63/109,813, entitled “BODY COMPRISING A FUNCTIONAL LAYER INCLUDING METAL ORGANIC FRAMEWORKS AND METHOD OF MAKING THE BODY,” by Ian KIDD et al., filed Nov. 4, 2020, which is assigned to the current assignee hereof and is incorporated herein by reference in its entirety.

### FIELD OF THE DISCLOSURE

The present disclosure relates to a body comprising a functional layer including metal organic frameworks (MOFs), a coating composition for making the functional layer, and a method of making the coated body.

### BACKGROUND

Metal organic frameworks (MOFs) are coordination networks of metal ions and organic ligands and are a class of compounds known for its unique combination of properties, such as high surface area, high porosity, and a flexible adsorption/desorption behavior. MOFs can be tailor-made for adsorbing a desired type of molecule or ion with high selectivity.

There exists a need of implementing MOFs in products for large-scale industrial use, such as in devices having a defined strength and long life-time, wherein the delicate network structure of MOFs can be integrated and maintained to a large extent.

### BRIEF DESCRIPTION OF THE DRAWINGS

The present disclosure may be better understood, and its numerous features and advantages made apparent to those skilled in the art by referencing the accompanying drawings.

FIG. 1A includes a scheme illustrating a method of making the body of the present disclosure according to one embodiment.

FIG. 1B includes a scheme illustrating a method of making the body of the present disclosure according to one embodiment.

FIG. 2 includes a line drawing illustrating a portion of the substrate and an overlying functional layer according to one embodiment.

FIG. 3A includes an optical image showing a top view of a section of a substrate including a functional layer according to one embodiment.

FIG. 3B includes an optical image of a perspective view of the complete coated substrate shown in FIG. 3A.

FIG. 4 includes a graph illustrating water absorption with varying relative humidity of MOF powder and functional layers including the MOF powder according to embodiments.

FIG. 5 includes a line drawing illustrating a load curve during measuring the adhesion loss factor (ALF) according to one embodiment.

### DETAILED DESCRIPTION

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The present disclosure is directed to a body comprising a substrate and a functional layer overlying at least a portion of the substrate, wherein the functional layer can comprise metal organic frameworks (MOFs).

The body can be designed for industrial applications of adsorbing/desorbing a desired type of molecule or ion. For example, in non-limiting embodiments, the body can be used for dehumidifying of air with a high efficiency and high life time, for storage of hydrogen, water and air purification, or in catalytic applications.

As used herein, the term “metal organic frameworks” (MOFs) relates to any compound forming a network of metal ions with coordinated organic ligands.

The method of forming the body of the present disclosure can comprise preparing a coating composition including MOFs and a binder, and applying the coating composition on a substrate.

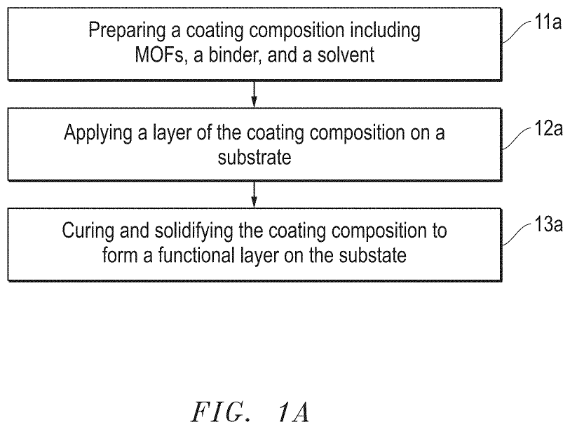

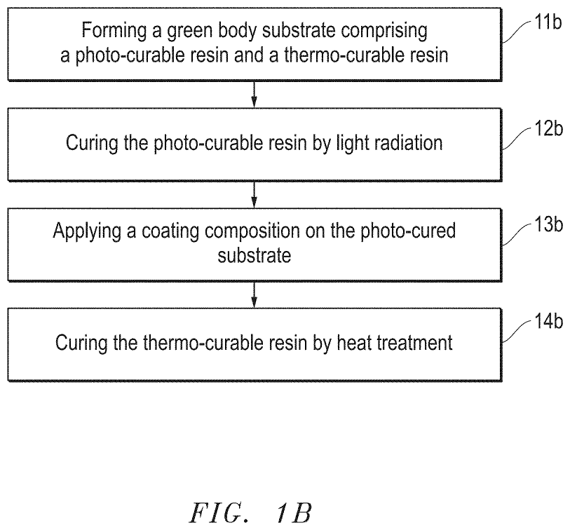

In one embodiment, a method of forming the body of the present disclosure can comprise: preparing a coating composition including metal organic frameworks (MOFs), a binder, and a solvent (11a); applying a layer of the coating composition on a substrate (12a); and curing the coating composition to form a functional layer on the substrate (13a), see FIG. 1A.

In one aspect, the binder of the coating composition can include at least one first binder compound and at least one second binder compound, wherein the at least one first binder compound can be dissolved in the solvent and the at least one second binder compound may not be dissolved in the solvent.

In a certain aspect, the first binder compound can include a cross-linking agent which can crosslink the at least one second binder compound.

In a particular embodiment, the first binder compound can include a water-soluble polymer and the second binder compound can include a water-insoluble polymer. In one aspect, the water-soluble polymer can be a cross-linking agent adapted for cross-linking the water-insoluble polymer during curing of the coating composition.

In one aspect, the water-soluble polymer can be a polysaccharide. In non-limiting embodiments, the polysaccharide can be a cellulose derivative, a starch derivative, an alginate, an alginate derivative, or any combination thereof. In a particular embodiment, the cellulose derivative can be carboxymethyl cellulose.

As used herein, the term “water-soluble” means that at least 0.2 g of the respective compound dissolves in 100 g water at 25° C.

In another embodiment, the at least one second compound of the binder in the coating composition can be a water-insoluble polymer. Non-limiting examples of a water-insoluble polymer can be a polyacrylate, a polystyrene, a polyurethane, an epoxide polymer, a polyimide, a polyamide, a polyester, or any combination or copolymer thereof. As used herein, the term polyacrylate includes substituted and non-substituted polyacrylates, for example, a polymethacrylate. The water-insoluble polymers can include functional groups which allow cross-linking reactions with the water-soluble polymer.

In another aspect, the second compound can also include at least one water-insoluble polymerizable monomer, for example, a mono- or di-functional acrylate monomer or an epoxide monomer or oligomer.

In a certain aspect, a weight percent ratio of the first binder compound to the second binder compound can range from 1:1 to 1:15, or from 1:1 to 1:10, or from 1:2 to 1:10, or from 1:3 to 1:8.

It has been surprisingly observed that coating composition containing certain combinations of binder compounds (herein called first binder compound and second binder compound), can form functional layers which may include MOFs and can have a high adhesive strength to the substrate.

As used herein, the adhesive strength of the functional layer to the substrate is expressed as the adhesion loss factor (ALF). As also in more detail described in the examples, the ALF is defined as the percentage of weight loss of the functional layer on a stainless steel substrate measured according to a modified ASTM E8 testing method.

In one embodiment, the adhesion factor (ALF) of the functional layer can be not greater than 7%, or not greater than 5%, or not greater than 4%, or not greater than 3%, or not greater than 2%, or not greater than 1%.

In one aspect, the binder of the functional layer can be an organic cross-linked polymer which is a reaction product of a water-insoluble polymer and a water-soluble polymer contained in the coating composition and formed after applying the coating composition on the substrate.

The binder of the functional layer of the present disclosure can be permeable to an analyte that can be adsorbed by the MOFs. Non-limiting examples of the analyte can be water, CO₂, hydrogen, methane, ammonia, a water pollutant, or an air pollutant.

In one embodiment, the functional layer can have a water absorption capacity of at least 15 g H₂O/g MOF at a temperature of 25° C. and a relative humidity of 30%, or at least 17 g H₂O/g MOF, or least 20 g H₂O/g MOF, or at least 25 g H₂O/g MOF, or at least 30 g H₂O/g MOF.

In another embodiment, the functional layer has a water absorption capacity of at least 15 g H₂O/g MOF at a temperature of 25° C. and a relative humidity of 80%, or at least 17 g H₂O/g MOF, or least 20 g H₂O/g MOF, or at least 25 g H₂O/g MOF, or at least 30 g H₂O/g MOF.

In one embodiment, the functional layer of the body of the present disclosure can comprise MOFs and may have a normalized functionality ratio (NFR) of at least 0.5.

The normalized functionality ratio (NFR) is defined herein as the ratio of a property of the MOFs within the functional layer to the property of the MOFs before inclusion in the functional layer. In one aspect, the property can be the surface area of the MOFs, or the adsorption capacity for an analyte, or the porosity of the MOFs, or the pore volume of the MOFs.

In certain aspects, the NFR can be at least 0.6, or at least 0.7, or at least 0.8, or at least 0.83, or at least 0.85, or at least 0.88, or at least 0.9, or at least 0.92, or at least 0.94, or at least 0.95.

The MOFs contained in the functional layer of the body of the present disclosure are not limited to a specific type of MOFs. The selection of the MOFs may depend on the intended use of the body of the present disclosure. Non-limiting examples of MOFs can be networks containing metal or transition metal ions aluminum, copper, iron, zirconium, zinc, or beryllium and organic ligands, for example, monovalent, divalent, trivalent, or tetravalent organic ligands. Examples of commercial MOFs can be: Mil-100, Numat 11, Numat25, HKUST-1, UIO-66, MOF-0, MOF-2, MOF-3, MOF-4, MOF-5, MOF-6, MOF-7, MOF-8 MOF-9, MOF-11, MOF-12, MOF-20, MOF-25, MOF-26, MOF-31, MOF-32, MOF-33, MOF-34, MOF-36, MOF-37, MOF-38, MOF-39, MOF-47, MOF-49, MOF-69a, MOF-69b, MOF-74, MOF-101, MOF-102, MOF-107, MOF-108, MOF-110, MOF-177, MOF-j, MOF-n, IRMOF-1, IRMOF-2, IRMOF-3, IRMOF-4, IRMOF-5, IRMOF-6, IRMOF-7, IRMOF-8, IRMOF-9, IRMOF-10, IRMOF-11, IRMOF-12, IRMOF-13, IRMOF-14, IRMOF-15, IRMOF-16, IRMOF-17, IRMOF-18, IRMOF-19, IRMOF-20, AS16, AS27-2, AS32, AS54-3, AS61-4, AS68-7, BPR43G2, BPR48A2, BPR49B1, BPR68D10, BPR69B1, BPR73E4, BPR76D5, BPR80D5, BPR92A2, BPR95C5, UiO-67, UiO-68, NO13, NO29, NO305, NO306A, NO330, NO332, NO333, NO335, NO336, HKUST-1, or MIL101.

In one embodiment, the metal organic frameworks can comprise an average particle size of at least 20 nm, such as at least 30 nm, or at least 50 nm, or at least 80 nm, or at least 100 nm, or at least 150 nm, or at least 200 nm. In another aspect, the average particle size of the MOFs may be not greater than 1000 μm, or not greater than 800 μm, or not greater than 500 μm, or not greater than 300 μm, or not greater than 100 μm, or not greater than 50 μm, or not greater than 20 μm, or not greater than 10 μm. The average particles size of the MOFs can be a value between any of the minimum and maximum values noted above.

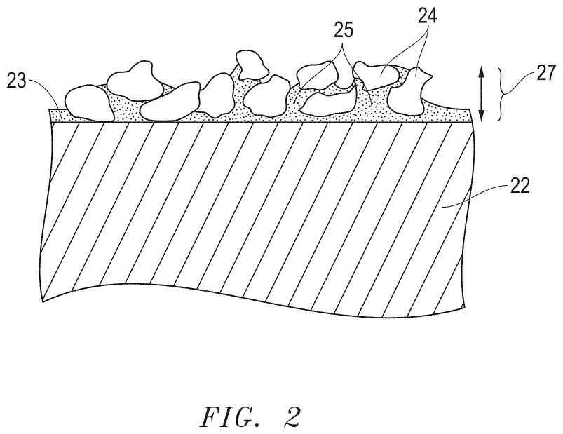

An embodiment of a functional layer (21) overlying a substrate (22) is illustrated in FIG. 2. The functional layer (21) can overly an outer surface (23) of the substrate (22), and may comprise to a high amount particles of MOFs (24) held together by the binder (25).

In one aspect, the ratio of the average thickness of the functional layer (21) to the average particle size (D50) of the MOFs (24) can be at least 1.3, or at least 1.5, or at least 2.5, or at least 3.0, or at least 5.0, or at least 8.0, or at least 10.0. In another aspect, the ratio of functional layer thickness to average particle size of the MOFs may be not greater than 50, or not greater than 30, or not greater than 25, or not greater than 20, or not greater than 15, or not greater than 10.0, or not greater than 5.0. The ratio of average thickness of the functional layer to the average particle size of the MOFs can be a value within a range including any of the minimum and maximum values noted above. In a certain particular aspect, the ratio of the average thickness of the functional layer to the D50 particle size of the MOFs can be between 1.5:1 to 2.5:1.

In another aspect, the average thickness of the coating layer (21) can be at least 0.5 microns, or at least 1 micron, or at least 5 microns, or at least 10 microns, or at least 15 microns, or at least 20 microns, or at least 30 microns, or at least 50 microns. In yet a further aspect, the average thickness of the coating layer may be not greater than 2000 microns, or not greater than 1500 microns, or not greater than 1000 microns, or not greater than 500 microns, or 200 microns, or 100 microns, or not greater than 50 microns, or not greater than 30 microns, or not greater than 20 microns, or not greater than 10 microns, or not greater than 5 microns, or not greater than 2 microns. The thickness of the functional layer can be a value within a range including any of the minimum and maximum values noted above.

In one embodiment, the functional layer can be a continuous conformal layer overlying the substrate; in another embodiment, the functional layer can be discontinuous.

In a certain embodiment, the MOFs can be shaped particles. In one aspect, the shaped particles can have an aspect ratio of length to width of greater than 1.0, such as greater than 1.2, or greater than 1.5, or greater than 2.0, or greater than 3.0, or greater than 5.0, or greater than 10.0.

In another particular certain aspect, the functional layer can comprise composite particles, wherein the composite particles can include the MOFs and boehmite. In one aspect, the composite particles can have an aspect ratio of length to width of greater than 1.0, such as greater than 1.2, or greater than 1.5, or greater than 2.0, or greater than 3.0, or greater than 5.0, or greater than 10.0.

In one embodiment, the functional layer can comprise a majority of the total weight MOF-agglomerates. In a particular aspect, a weight % ratio of the MOFs to the binder can be not greater than 2:1, or not greater than 5:1, or not greater than 10:1, or not greater than 15:1, or not greater than 20:1, or not greater than 25:1, or not greater than 30:1. In another aspect, the weight % ratio of the MOFs to the binder may be at least 40:1, or at least 35:1, or at least 30:1, or at least 25:1. The weight % ratio of the MOFs to the binder can be a value within a range including any of the minimum and maximum values noted above, such as from 2:1 to 40:1, or from 5:1 to 30:1, or from 10:1 to 25:1, or from 15:1 to 20:1.

In another aspect, the amount of the MOFs in the functional layer can be at least 70 wt % based on the total weight of the functional layer, such as at least 75 wt %, at least 80 wt %, at least 85 wt %, at least 90 wt %, at least 95 wt %, or at least 97 wt %. In a further aspect, the amount of MOFs in the functional layer may be not greater than 99 wt %, or not greater than 97 wt %, or not greater than 95 wt % based on the total weight of the functional layer. The amount of the MOFs in the functional layer can be a value within a range including any of the minimum and maximum values noted above.

In another embodiment, the amount of the binder contained in the functional layer may be not greater than 30 wt %, such as not greater than 25 wt %, not greater than 20 wt %, not greater than 15 wt %, not greater than 10 wt %, not greater than 5 wt %, or not greater than 3 wt %. In yet another aspect, the amount of the binder can be at least 1 wt % based on the total weight of the coating, such as at least 3 wt %, or at least 5 wt %. The amount of the binder can be within a range including any of the minimum and maximum values noted above.

The present disclosure is further directed to a coating composition adapted to be applied on a substrate to form a functional layer of a body.

In one embodiment, the coating composition can comprise MOFs, a binder, and a solvent, wherein the binder can include at least one first binder compound and at least one second binder compound, the at least one first binder compound being dissolved in the solvent and the at least one second binder compound not being dissolved in the solvent.

In one aspect, a wt % ratio of the MOFs to the binder of the coating composition can range from 2:1 to 40:1. In certain aspects, the wt % ratio of the MOFs to the binder can range from 5:1 to 30:1, from 10:1 to 25:1, or from 15:1 to 20:1.

In a particular embodiment, the solvent of the coating composition can include water. In a certain particular embodiment, the solvent can consist essentially of water except for unavoidable impurities.

In a further certain aspect, the coating composition can include one or more optional additives, for example, a surfactant, a dispersing agent, a pH modifier, a buffer, a filler, or a viscosity modifying agent.

The coating composition can be designed that it may have a suitable viscosity for conducting a selected method of applying the coating composition on the surface of the substrate. In one embodiment, the viscosity of the coating composition can be at least 2 cP, or at least 5 cP, or at least 10 cP, or at least 50 cP, or at least 100 cP. In another embodiment, the viscosity may be not greater than 1500 cP, or not greater than 1000 cP, or not greater than 800 cP, or not greater than 500 cP, or not greater than 200 cP, or not greater than 100 cP, or not greater than 50 cP, at a shear rate of 10/s. The viscosity of the coating composition can be a value between any of the minimum and maximum values noted above.

In one aspect, the viscosity of coating composition can be adjusted by the amount of water. In a particular aspect, the coating composition can comprise at least 60 wt % water, such as at least 65 wt % water, at least 70 wt %, at least 75 wt %, or at least 80 wt %.

In one embodiment, the at least one first binder compound of the coating composition can include a water-soluble polymer.

In one aspect, the water-soluble polymer of the coating composition can include a polysaccharide. Non-limiting examples of the polysaccharide can be a cellulose derivative, a starch derivative, an alginate, an alginate derivative, or any combination thereof. In a certain particular aspect, the cellulose derivative can include a carboxymethyl cellulose.

The at least one second binder compound can include a water-insoluble polymer or a water-insoluble polymerizable monomer. Non-limiting examples of the water-insoluble polymer can be polyacrylate, a polystyrene, a polyurethane, an epoxide polymer, or any combination or copolymers thereof.

In a particular embodiment, the first binder compound can include a carboxymethyl cellulose, and the second binder compound includes an acrylate polymer.

In another particular embodiment, the coating composition can comprise MOFs, sodium alginate, and water. In one aspect, in order to solidify the coating composition after application on a substrate, the coating composition can be treated with a calcium chloride containing solution. In a certain aspect, the calcium chloride containing solution may be applied by spraying to a layer of the coating composition on a substrate. The calcium chloride can cause a cross-linking reaction of the alginate and thereby hardening of the coating layer. In another aspect, the calcium chloride can be added to the coating composition shortly before its application to the substrate surface.

In a further aspect, the coating composition can have a pH between 1 and 12, particularly between 7 and 11, and in a certain particular aspect between 8-10.

In one aspect, the amount of MOFs in the coating composition can be at least 1 wt % based on the total weight of the coating composition, or at least 5 wt %, or at least 10 wt %, or at least 15 wt %, or at least 20 wt %, or at least 25 wt %, or at least 30 wt %. In another aspect, the amount of MOFs may be not greater than 50 wt %, or not greater than 40 wt %, or not greater than 30 wt %, or not greater than 25 wt %, or not greater than 20 wt %. The amount of MOFs in the coating composition can be a value between any of the minimum and maximum numbers noted above.

In a further aspect, the amount of the total amount of binder in the coating composition can be at least 0.1 wt % based on the total weight of the coating composition, or at least 0.5 wt %, or at least 1 wt %, or at least 2 wt %, or at least 5 wt %. In another aspect, the amount of the binder in the coating composition may be not greater than 30 wt %, or not greater than 20 wt %, or not greater than 10 wt %, or not greater than 5 wt %, or not greater than 3 wt %. The amount of binder in the coating composition can be a value between any of the minimum and maximum numbers noted above.

In yet a further aspect, the amount of solvent in the coating can be at least 50 wt % based on the total weight of the coating composition, such as at least 60 wt %, or at least 70 wt %, or at least 75 wt %, or at least 80 wt %. In another aspect, the amount of the solvent may be not greater than 95 wt % based on the total weight of the coating composition, or not greater than 90 wt %, or not greater than 80 wt %, or not greater than 75 wt %. The amount of solvent in the coating composition can be a value between any of the minimum and maximum numbers noted above.

In another embodiment, in order to obtain a desired adhesive strength of the functional layer to the underlying substrate, a selection of the substrate material and the material of the functional layer can be made that covalent bonds may be formed between the substrate and the functional layer.

In one aspect, the substrate can be a polymer or ceramic comprising functional groups which can react with functional groups of a compound contained in the coating composition, for example, with the binder or the MOFs.

In one embodiment of the method, the substrate can be a polymeric substrate formed from a combination of two different types of polymerizable resins, wherein each resin type may cure under a different condition.

An embodiment of the method of making such a substrate and applying a functional layer on the substrate to form the body of the present disclosure is illustrated in FIG. 1B. In a first step, a green body substrate can be formed from a mixture comprising a photo-curable resin and a thermo-curable resin (11b). After forming of the green body substrate, the green body substrate may be subjected to light radiation to cure the photo-curable resin and thereby forming a partially cured substrate (12b). Thereafter, a layer of a coating composition can be applied on the partially cured substrate to form a coated partially cured substrate, wherein the coating composition can comprise MOFs (13b). After applying the coating composition, the coated partially cured substrate may be subjected to heat treating for curing the thermo-curable resin of the partially cured substrate (14b). Not to be bound to theory, it is assumed that during heat treating to cure the thermo-curable resin, covalent bondings can be formed between the applied coating composition and the thermo-curable resin, thereby producing MOFs containing functional layer having one or more combinations or features as provided in embodiments herein.

In another embodiment, the substrate of the body of the present disclosure can be a combination of the polymeric material with a metal, metal alloy, or ceramic material, wherein only the outer region of the substrate may include the polymeric material and can be in direct contact with the functional layer.

In yet a further embodiment, the substrate may be a surface roughened ceramic, a surface roughened metal, or a surface roughened metal alloy, or a surface roughened polymer.

In one particular embodiment, the body of the present disclosure can be a filter adapted for filtering a gas or a fluid by adsorbing a specific analyte. In a certain aspect, the filter can be a dehumidifier.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### EMBODIMENTS

Embodiment 1. A body comprising: a substrate; and a functional layer overlying at least a portion of a surface of the substrate, wherein the functional layer comprises metal organic frameworks (MOFs) and a binder, the binder including an organic polymer, and an adhesion loss factor (ALF) of the functional layer to the substrate is not greater than 7%.

Embodiment 2. The body of Embodiment 1, wherein the adhesion loss factor (ALF) of the functional layer is not greater than 6%, or not greater than 5%, or not greater than 4%, or not greater than 3%, or not greater than 2%, or not greater than 1%.

Embodiment 3. The body of Embodiment 1, wherein the functional layer has a water absorption capacity of at least 15 g H₂O/g MOF at a temperature of 25° C. and a relative humidity of 30%, or at least 17 g H₂O/g MOF, or least 20 g H₂O/g MOF, or at least 25 g H₂O/g MOF, or at least 30 g H₂O/g MOF.

Embodiment 4. The body of Embodiment 1, wherein the functional layer has a water absorption capacity of at least 15 g H₂O/g MOF at a temperature of 25° C. and a relative humidity of 80%, or at least 17 g H₂O/g MOF, or least 20 g H₂O/g MOF, or at least 25 g H₂O/g MOF, or at least 30 g H₂O/g MOF.

Embodiment 5. The body of any one of the preceding Embodiments, wherein a material of the substrate includes a metal, a metal alloy, a ceramic, or a polymer.

Embodiment 6. The body of Embodiment 5, wherein the material of the substrate includes a metal.

Embodiment 7. The body of Embodiment 6, wherein the material of the substrate includes stainless steel.

Embodiment 8. The body of any one of the preceding Embodiments, wherein the functional layer is directly overlying an outer surface of the substrate.

Embodiment 9. The body of any one of the preceding Embodiments, wherein the organic polymer of the binder is an organic cross-linked polymer.

Embodiment 10. The body of Embodiment 9, wherein the organic cross-linked polymer is a reaction product of a water-insoluble polymer and a water-soluble polymer.

Embodiment 11. The body of any one of Embodiments 9 or 10, wherein the water-soluble polymer includes a polysaccharide.

Embodiment 12. The body of Embodiment 11, wherein the polysaccharide includes a cellulose derivative, or a starch derivative, an alginate, or an alginate derivative.

Embodiment 13. The body of any one of Embodiments 10-12, wherein the water-soluble polymer is a carboxymethyl cellulose.

Embodiment 14. The body of any one of Embodiments 10-13, wherein the water-insoluble polymer includes at least one polyacrylate, a polystyrene, an epoxide polymer, a polyurethane, a polyester, a polyether, a polyamide, a polyimide, or any combination or copolymer thereof.

Embodiment 15. The body of Embodiment 14, wherein the water-insoluble polymer includes a polyacrylate, or a polystyrene, or a polyacrylate-polystyrene copolymer.

Embodiment 16. The body of Embodiment 8-15, wherein cross-linked polymeric binder is a cross-linked polyacrylate, a cross-linked epoxide, or a cross-linked polyurethane, or a cross-linked polyimide, of a cross-linked polyamide, or any combination thereof.

Embodiment 17. The body of Embodiment 16, wherein the cross-linked polymeric binder is a cross-linked polyacrylate.

Embodiment 18. The body of Embodiment 17, wherein the cross-linked polymeric binder consists essentially of the cross-linked polyacrylate.

Embodiment 19. The body of any one of the preceding Embodiments, wherein the functional layer has a normalized functionality ratio (NFR) of at least 0.5, the NFR being a ratio of a property of the MOFs within the functional layer to the property of the MOFs before inclusion in the functional layer.

Embodiment 20. The body of any one of the preceding Embodiments, wherein the functional layer comprises a normalized functionality ratio (NFR) of at least 0.5, the NFR being a ratio of a property of the MOFs within the functional layer to the property of the MOFs before inclusion in the functional layer.

Embodiment 21. The body of Embodiment 20, wherein the property of the NFR is selected from a surface area; an adsorption capacity for an analyte; water absorption, a pore volume; or a porosity.

Embodiment 22. The body of Embodiment 12, wherein the NFR is at least 0.6, or at least 0.7, or at least 0.8, or at least 0.83, or at least 0.85, or at least 0.88, or at least 0.9, or at least 0.92, or at least 0.94, or at least 0.95.

Embodiment 23. The body of any one of Embodiment 20-22, wherein the NFR of a water absorption of the functional layer is at least 0.7, or at least 0.75, or at least 0.8, or at least 0.85, or at least 0.9, or at least 0.95.

Embodiment 24. The body of any one of the preceding Embodiments, wherein the MOFs comprise an average particle size (D50) of at least 20 nm, such as at least 30 nm, at least 50 nm, at least 80 nm, at least 100 nm, at least 150 nm, or at least 200 nm.

Embodiment 25. The body of any one of the preceding Embodiments, wherein the MOFs comprise an average particle size (D50) of not greater than 1000 microns, or not greater than 800 microns, or not greater than 500 microns, or not greater than 300 microns, or not greater than 200 microns, or not greater than 100 microns, or not greater than 50 microns, or not greater than 10 microns, or not greater than 5 microns, or not greater than 1 micron, or not greater than 0.5 microns, or not greater than 0.1 microns.

Embodiment 26. The body of any one of the preceding Embodiments, wherein the MOFs can be shaped particles.

Embodiment 27. The body of Embodiment 26, wherein an aspect ratio of length to width of the shaped particles is greater than 1.0.

Embodiment 28. The body of Embodiment 27, wherein the aspect ratio is least 1.1, or at least 1.5, or at least 2.0, or at least 3.0, or at least 5.0, or at least 10.0.

Embodiment 29. The body of any one of the precedent Embodiments, wherein the functional layer further comprises an inorganic binder.

Embodiment 30. The body of Embodiment 29, wherein the inorganic binder comprises hydroxyl groups.

Embodiment 31. The body of any one of Embodiments 29 or 30, wherein the inorganic binder comprises boehmite.

Embodiment 32. The body of Embodiment 23, wherein the inorganic binder further comprises hydrated alumina.

Embodiment 33. The body of any one of the precedent Embodiments, wherein a weight % ratio of the MOFs to the binder is not greater than 2:1, or not greater than 5:1, or not greater than 10:1, or not greater than 15:1, or not greater than 20:1, or not greater than 25:1, or not greater than 30:1.

Embodiment 34. The body of any one of the precedent Embodiments, wherein a weight % ratio of the MOFs to the binder is at least 40:1, or at least 35:1, or at least 30:1, or at least 25:1.

Embodiment 35. The body of any one of the precedent Embodiments, wherein a weight % ratio of the MOFs to the binder ranges from 2:1 to 40:1, such as from 5:1 to 30:1 or from 10:1 to 25:1, or from 15:1 to 20:1.

Embodiment 36. The body of any one of the precedent Embodiments, wherein an amount of the MOFs in the functional layer is at least 70 wt % based on the total weight of the coating, such as at least 75 wt %, at least 80 wt %, at least 85 wt %, at least 90 wt %, at least 95 wt %, or at least 98 wt %.

Embodiment 37. The body of any one of the precedent Embodiments, wherein an amount of the MOFs in the functional layer is not greater than 99 wt % based on the total weight of the functional layer, such as not greater than 97 wt %, or not greater than 95 wt %.

Embodiment 38. The body of any one of the precedent Embodiments, wherein an amount of the binder in the functional layer is not greater than 30 wt % based on the total weight of the functional layer, or not greater than 25 wt %, or not greater than 20 wt %, or not greater than 15 wt %, or not greater than 10 wt %, or not greater than 5 wt %, or not greater than 3 wt %.

Embodiment 39. The body of any one of the precedent Embodiments, wherein an amount of the binder in the functional layer is at least 1 wt % based on the total weight of the functional layer, or at least 3 wt %, or at least 5 wt %.

Embodiment 40. The body of any one of the precedent Embodiments, wherein the MOFs comprise aluminum fumarate, or mil-100, or numat-11, or Numat-25, or UIO-66, or a transition metal based MOF, or MOF-0, MOF-2, MOF-3, MOF-4, MOF-5, MOF-6, MOF-7, MOF-8 MOF-9, MOF-11, MOF-12, MOF-20, MOF-25, MOF-26, MOF-31, MOF-32, MOF-33, MOF-34, MOF-36, MOF-37, MOF-38, MOF-39, MOF-47, MOF-49, MOF-69a, MOF-69b, MOF-74, MOF-101, MOF-102, MOF-107, MOF-108, MOF-110, MOF-177, MOF-j, MOF-n, IRMOF-1, IRMOF-2, IRMOF-3, IRMOF-4, IRMOF-5, IRMOF-6, IRMOF-7, IRMOF-8, IRMOF-9, IRMOF-10, IRMOF-11, IRMOF-12, IRMOF-13, IRMOF-14, IRMOF-15, IRMOF-16, IRMOF-17, IRMOF-18, IRMOF-19, IRMOF-20, AS16, AS27-2, AS32, AS54-3, AS61-4, AS68-7, BPR43G2, BPR48A2, BPR49B1, BPR68D10, BPR69B1, BPR73E4, BPR76D5, BPR80D5, BPR92A2, BPR95C5, UiO-67, UiO-68, NO13, NO29, NO305, NO306A, NO330, NO332, NO333, NO335, NO336, HKUST-1, MIL101, or any combination thereof.

Embodiment 41. The body of any one of the precedent Embodiments, wherein the functional layer comprises an average thickness of at least 0.5 microns, or at least 1 micron, such as at least 5 microns, or at least 10 microns, or at least 15 microns, or at least 20 microns, or at least 30 microns, or at least 50 microns, or at least 200 microns, or at least 150 microns, or at least 200 microns.

Embodiment 42. The body of any one of the precedent Embodiments, wherein the functional layer comprises an average thickness of not greater than 2000 microns, or not greater than 1500 microns, or not greater than 1000 microns, or not greater than 800 microns, or not greater than 500 microns, or not greater than 300 microns, or not greater than 200 microns, or not greater than 100 microns, or not greater than 50 microns, or not greater than 30 microns, or not greater than 20 microns, or not greater than 10 microns, or not greater than 5 microns, or not greater than 2 microns.

Embodiment 43. The body of any one of the precedent Embodiments, wherein a ratio of an average thickness of the functional layer to an average particle size (D50) of the MOFs is at least 1.3, or at least 1.5, or at least 2.0, or at least 2.5, or at least 3.0, or at least 5.0, or at least 8.0, or at least 10.0.

Embodiment 44. The body of any one of the precedent Embodiments, wherein a ratio of an average thickness of the functional layer to an average particle size (D50) of the MOFs is not greater than 50.0, or not greater than 30, or not greater than 25, or not greater than 20, or not greater than 15, or not greater than 10.0, or not greater than 5.0.

Embodiment 45. The body of Embodiment 5, wherein the substrate comprises a polymer.

Embodiment 46. The body of Embodiment 45, wherein the polymer of the substrate comprises at least two different types of homo-polymers, co-polymers, cross-polymers, or any combination thereof.

Embodiment 47. The body of any one of Embodiments 45 or 46, wherein the polymer comprises an epoxy polymer, a polyacrylate, a polymethacrylate, a polycarbonate, a polyester, a polyimide, a polyurethane, or any combination thereof.

Embodiment 48. The body of any one of Embodiments 45-47, wherein the polymer comprises a photo-cured polymer and a thermally cured polymer.

Embodiment 49. The body of Embodiment 48, wherein the photo-cured polymer comprises an acrylate polymer, and the thermally cured polymer comprises an epoxy polymer.

Embodiment 50. The body of any one of Embodiments 45-49, wherein the functional layer is attached to the substrate by covalent bodings between the functional layer and the substrate.

Embodiment 51. The body of any one of Embodiments 45-50, wherein the covalent bondings include covalent bondings formed between functional groups of the binder and functional groups of the substrate.

Embodiment 52. The body of any one of Embodiments 45-51, wherein the covalent bondings include covalent bondings formed between functional groups of the binder and functional groups of a polymer contained in the substrate.

Embodiment 53. The body of any one of the precedent Embodiments, wherein the functional layer comprises a first pore structure and a second pore structure, wherein the first pore structure relates to open pores within the particles of the MOFs, and the second pore structure related to open pores formed within the binder and between the binder and the particles of the MOFs.

Embodiment 54. The body of Embodiment 53, wherein an average pore size of the first pore structure is different than an average pore size of a second pore structure.

Embodiment 55. The body of Embodiments 53 or 54, wherein the average pore size of the second pore structure is greater than the average pore size of the first pore structure.

Embodiment 56. The body of any one of the precedent Embodiments, wherein the binder is permeable to an analyte that can be adsorbed by the MOFs.

Embodiment 57. The body of Embodiment 56, wherein the analyte includes at least one of water, CO2, hydrogen, a water pollutant, or an air pollutant.

Embodiment 58. The body of any one of the precedent Embodiments, wherein the functional layer comprises composite particles, the composite particles including MOFs and boehmite.

Embodiment 59. The body of Embodiment 58, wherein the composite particles comprise an aspect ratio of 1, or at least 1.2, or at least 1.5, or at least 2.0, or at least 3.0, or at least 5.0, or at least 10.0.

Embodiment 60. The body of Embodiments 58 or 59, wherein the composite particles comprise at least 90 wt % MOFs based on the total weight of the composite particles.

Embodiment 61. A coating composition comprising metal organic frameworks (MOFs), a binder, and a solvent, wherein the binder includes at least one first binder compound and at least one second binder compound, the at least one first binder compound being dissolved in the solvent and the at least one second binder compound not being dissolved in the solvent.

Embodiment 62. The coating composition of Embodiment 61, wherein the solvent is water.

Embodiment 63. The coating composition of Embodiments 61 or 62, wherein the at least one first binder compound includes a cross-linking agent.

Embodiment 64. The coating composition of any one of Embodiments 61-63, wherein the at least one first binder compound includes a water-soluble polymer and the at least one second binder compound includes a water-insoluble polymer.

Embodiment 65. The coating composition of any one of Embodiments 61-64, wherein the at least one first binder compound includes a polysaccharide.

Embodiment 66. The coating composition of Embodiment 65, wherein the polysaccharide is selected from a cellulose derivative, a starch derivative, an alginate, an alginate derivative, or any combination thereof.

Embodiment 67. The coating composition of Embodiment 66, wherein the cellulose derivative includes a carboxymethyl cellulose.

Embodiment 68. The coating composition of Embodiment 67, wherein the at least one second binder compound includes as water-insoluble polymer.

Embodiment 69. The coating composition of Embodiment 68, wherein the water-insoluble polymer of the second binder compound includes at least one polyacrylate, or a polystyrene, or a polyurethane, an epoxide polymer, a polyimide, a polyamide, a polyester, or any combination or copolymer thereof.

Embodiment 70. The coating composition of any one of Embodiments 61 to 69, wherein the first binder compound includes a carboxymethyl cellulose, and the second binder compound includes an acrylate polymer.

Embodiment 71. The coating composition of any one of Embodiments 61-70, wherein a weight % ratio of the at least one first binder compound to the at least one second binder compound ranges from 1:1 to 1:15.

Embodiment 72. The coating composition of Embodiment 70, wherein the weight % ratio of the at least one first binder compound to the at least one second binder compound ranges from 1:2 to 1:10.

Embodiment 73. The coating composition of any one of Embodiments 61-72, wherein the MOFs comprise an average particle size of at least 20 nm, such as at least 30 nm, or at least 50 nm, or at least 80 nm, or at least 100 nm, or at least 150 nm, or at least 200 nm.

Embodiment 74. The coating composition of any one of Embodiments 61-73, wherein the MOFs comprise an average particle size of not greater than 1000 microns, or not greater than 800 microns, or not greater than 500 microns, or not greater than 300 microns, or not greater than 200 microns, or not greater than 100 microns, or not greater than 50 microns, or not greater than 10 microns, or not greater than 5 microns, or not greater than 1 micron, or not greater than 0.5 microns, or not greater than 0.1 microns.

Embodiment 75. The coating composition of any one of Embodiments 61-74, wherein a viscosity of the coating composition is not greater than 5000 cP, or not greater than 3000 cP, or not greater than 1000 cP, or not greater than 500 cP, or not greater than 100 cP, or not greater than 50 cP at a shear rate of 10/s.

Embodiment 76. The coating composition of any one of Embodiments 61-75, wherein the viscosity of the coating composition is at least 2 cP, or at least 5 cP, or at least 10 cP, or at least 50 cP, or at least 100 cP at a shear rate of 10/s.

Embodiment 77. The coating composition of any one of Embodiments 61-76, wherein an amount of the MOFs is at least 5 wt % based on the total weight of the coating composition, or at least 10 wt %, or at least 20 wt %, or at least 30 wt %, or at least 40 wt %, or at least 50 wt %.

Embodiment 78. The coating composition of any one of Embodiments 61-77, wherein an amount of the MOFs is not greater than 85 wt % based on the total weight of the coating composition, or not greater than 80 wt %, or not greater than 70 wt %, or not greater than 60 wt %, or not greater than 50 wt %, or not greater than 45 wt %, or not greater than 40 wt %, or not greater than 30 wt %.

Embodiment 79. The coating composition of any one of Embodiments 61-78, wherein an amount of the binder is at least 0.5 wt % based on the total weight of the coating composition, or at least 1 wt %, or at least 2 wt %, or at least 3 wt %, or at least 5 wt %, or at least 7 wt %, or at least 10 wt %.

Embodiment 80. The coating composition of any one of Embodiments 61-78, wherein an amount of the binder is not greater than 50 wt % based on the total weight of the coating composition, or not greater than 30 wt %, or not greater than 20 wt %, or not greater than 15 wt %, or not greater than 10 wt %, or not greater than 8 wt %, or not greater than 5 wt %.

Embodiment 81. The coating composition of any one of Embodiments 61-80, wherein a weight % ratio of the at least one water-soluble polymer to the at least one water-insoluble polymer ranges from 1:1 to 1:15, or from 1:2 to 1:10.

Embodiment 82. The coating composition of any one of Embodiments 61-76, wherein the binder further comprises an inorganic compound.

Embodiment 83. The coating composition of any one of Embodiments 61-77, wherein the inorganic binder comprises a metal oxide/hydroxide or a polysaccharide.

Embodiment 84. The coating composition of any one of Embodiments 61-78, wherein the binder includes boehmite.

Embodiment 85. The coating composition of any one of Embodiments 61-79, wherein the binder includes sodium alginate.

Embodiment 86. The coating composition of any one of Embodiments 61-80, wherein the solvent includes water.

Embodiment 87. The coating composition of any one of Embodiments 61-86, further comprising a surfactant.

Embodiment 88. The coating composition of any one of Embodiments 61-87, wherein an amount of the MOFs is at least 0.1 wt % based on the total weight of the coating compositions, such as at least 0.5 wt %, or at least 1 wt %, or at least 5 wt %, or at least 10 wt %, or at least 15 wt %, or at least 20 wt %.

Embodiment 89. The coating composition of any one of Embodiments 61-88, wherein an amount of the MOFs is not greater than 40 wt % based on the total weight of the coating composition, such as not greater than 30 wt %, not greater than 25 wt %, or not greater than 20 wt %.

Embodiment 90. The coating composition of any one of Embodiments 61-89, wherein an amount of the binder is at least 0.1 wt % based on the total weight of the coating composition, such as at least 0.5 wt %, or at least 1 wt %, or at least 2 wt %, or at least 5 wt %.

Embodiment 91. The coating composition of any one of Embodiments 61-90, wherein an amount of the binder is not greater than 30 wt %, or not greater than 20 wt %, or not greater than 10 wt %, or not greater than 5 wt %, or not greater than 3 wt % based on the total weight of the coating composition.

Embodiment 92. The coating composition of any one of Embodiments 61-91, wherein an amount of the solvent is at least 50 wt % based on the total weight of the coating composition, such as at least 60 wt %, or at least 70 wt %, or at least 75 wt %, or at least 80 wt %.

Embodiment 93. The coating composition of any one of Embodiments 61-92, wherein an amount of the solvent is not greater than 95 wt % based on the total weight of the coating composition, or not greater than 90 wt %, or not greater than 80 wt %, or not greater than 75 wt %.

Embodiment 94. A method of forming a body comprising a substrate and a functional layer overlying the substrate, the method comprising: forming a green body substrate from a mixture, the mixture comprising at least one photo-curable resin and at least one thermo-curable resin; at least partially curing the photo-curable resin of the green body by light radiation to form a partially cured substrate; applying a layer of a coating composition on the partially cured substrate to form a coated partially cured substrate, wherein the coating composition comprises MOFs; and heat treating the coated partially cured substrate to cure the thermo-curable resin to form the body comprising a substrate and a functional layer overlying the substrate.

Embodiment 95. The method of Embodiment 94, wherein covalent bondings are formed during heat treating between functional groups of the substrate and functional groups of the functional layer.

Embodiment 96. The method of Embodiments 95 or 95, wherein the photo-curable resin comprises acrylate groups or methacrylate groups.

Embodiment 97. The method of any one of Embodiments 95-96, wherein the thermo-curable resin comprises epoxy-groups, hydroxyl-groups, amine groups, or any combination thereof.

Embodiment 98. The method of any one of Embodiments 95-97, wherein curing of the photo-curable resin is conducted by radiation with UV light.

Embodiment 99. The method of any one of Embodiments 95-98, wherein heat treating to cure the thermo-curable resin is conducted at a temperature of at least 50° C., or at least 70° C. or at least 80° C.

Embodiment 100. The method of any one of Embodiments 95-99, wherein heat treating to cure the thermo-curable resin is conducted at a temperature not greater than 150° C., or 120° C., or 100° C.

Embodiment 101. The method of any one of Embodiments 61-100, wherein applying the coating composition is conducted by dip-coating.

Embodiment 102. A filter comprising the body of any one of Embodiments 1-60, wherein the filter is adapted for adsorbing an analyte.

Embodiment 103. The filter of Embodiment 102, wherein the filter is adapted for filtering a gas or a fluid.

Embodiment 104. The filter of Embodiments 103 or 103, wherein the analyte is selected from water, CO2, hydrogen, a water pollutant, or an air pollutant.

Embodiment 105. The filter of any one of Embodiments 103-104, wherein the filter is a dehumidifier.

### EXAMPLES

The following non-limiting examples illustrate the present invention.

### Example 1

Making Coating Compositions Including MOFs.

Four coating compositions were prepared by using two different types of MOFs and two different types of binders, as also summarized in Table 1. The MOFs used in coating compositions S1 and S2 were aluminum fumarate (A520 from Novamof), having an average particle size (D50) of 9.3 μm, and a surface area of 890 m²/g. The MOFs used for making coating compositions S3 and S4 were an iron-based MOF (Mil-100), having an average particle size of 34 μm and a surface area of 1200 m²/g.

As binders were used sodium alginate (samples S1 and S3), and boehmite (samples S2 and S4).

The coating compositions were prepared by dispersing 1 wt % binder in 79 wt % distilled water using a shear mixer until the binder was dissolved, followed by slowly adding 20 wt % of the MOF-powder. All wt % amounts relate to the total amount of the final coating composition before applying it on the substrate. The viscosities of the compositions including the aluminum fumarate MOF were between 600 cP and 800 cP. The pH for all compositions was between 9 and 10.

TABLE 1

Particle size of
MOFs [μm]

| Sample | MOFs | D50 | D90 | Binder |
|---|---|---|---|---|
| S1 | Aluminum | 9.7 | 27 | Na-alginate |
| | Fumarate | | | |
| | (A520) | | | |
| S2 | Aluminum | 9.7 | 27 | Boehmite |
| | Fumarate | | | |
| | (A520) | | | |
| S3 | Fe-MOF | 34 | 158 | Na-alginate |
| | (Mil-100) | | | |
| S4 | Fe-MOF | 34 | 158 | Boehmite |
| | (Mil-100) | | | |

### Example 2

Making Functional Layers Using Coating Compositions Including Na Alginate as Binder.

Coating composition S1 of Example 1 was applied via dip-coating on a variety of substrates made of different materials: 1) aluminum, 2) surface-roughened aluminum, 3) polycarbonate, 4) surface-roughened polycarbonate, and 5) a dual-cured polymeric substrate. The alumina and polycarbonate substrates had a circular wheel shape with 3 inches diameter, and triangular sub-sections. The formed dual-cured polymeric substrate had an 8 inche diameter shape with triangular sub-sections, and was designed as an entropy wheel for use in a dehumidifier.

For applying the coatings on the substrates, each substrate was fully dipped in the respective coating composition for 3 seconds. The temperature of the coating compositions was room-temperature. Thereafter, while still being liquid, the applied coating composition layer was sprayed with a 30 wt % CaCl₂ solution using a spray bottle in order to initiate gelling and solidification of the coating composition to form a solid functional layer. After the treatment with the CaCl₂ solution, the coating composition solidified within about 30 seconds. The thickness of the applied functional coatings was about twice the average size of the MOF particles.

The dual-cured polymeric substrate (5) was made by forming via 3D printing a green body substrate using a two-component resin system, of which the first component was a photo-curable acrylic resin, and the second component was a thermo-curable epoxy resin (a diglycidyl ether bisphenol based resin). In view of the large size of the wheel (8 inches diameter), the wheel was divided in four quarters, and each quarter wheel part was 3D printed separately and also separately coated and cured before being assembled.

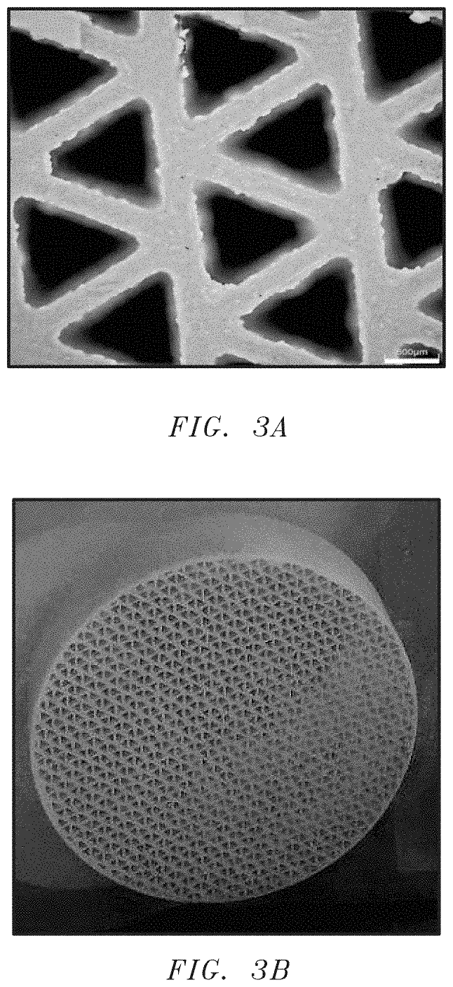

Curing of the green body wheel substrate was conducted first by subjecting the green body parts to UV radiation to photo-cure the acrylic resin. Thereafter, the partially cured substrate part was dipped for 3 seconds in coating composition S1. After the dip-coating, the applied coating composition was treated with a 30 wt % CaCl₂ solution by spraying with a spray bottle to initiate solidifying of the coating, followed by a heat treatment at 70° C. for 120 minutes in order to cure the thermo-curable epoxy resin of the green body substrate. An image of a section of the coated entropy wheel can be seen in FIG. 3A. The image shows a section of coated triangular channels, having a length of 2 mm. The complete wheel had a diameter of eight inches and a thickness of 0.5 inches. An image of the complete structure of the wheel design can be seen in FIG. 3B.

The applied coating layers (herein also called functional layers) on the different substrate types were evaluated by their adhesion to the substrate. No sufficient adhesion of the functional layers could be observed when using non-roughened aluminum or non-roughened polycarbonate substrate. After roughening the aluminum and carbonate substrate surfaces via sandblasting, the adhesion of the dip-coated layers was much improved. Excellent adhesion could be observed using as substrate the polymeric substrate made by the dual-curing resin system, wherein dip-coating was conducted after the UV curing and before thermal curing, see also Table 2.

TABLE 2

| | Adherence of Functional |
|---|---|
| Substrate type | Layer to Substrate |
| 1) Aluminum | not sufficient |
| 2) roughened Aluminum | good |
| 3) Polycarbonate | not sufficient |
| 4) roughened polycarbonate | good |
| 5) Dual-cured polymeric | good |
| substrate - coating applied after UV | |
| curing and before heat curing | |

It was not possible to form desirable functional layers when using coating composition S3 (including iron-containing MOF Nil-100 and alginate binder) and conducting the dip-coating and curing on any of the five substrate materials.

### Example 3

Making Functional Layers Using Coating Compositions Including Boehmite as Binder.

The same dip-coating coating experiments as conducted in Example 2 were conducted with coating compositions S2 and S4, which included boehmite as a binder and MOFs A520 (S2) or Mil-100 (S4), see Table 1. As substrate was used the same type of 3D printed dual-cured polymeric entropy-wheel having a diameter of 8 inches. After UV curing, the coating composition was applied via dip-coating to the partially cured substrate. After the dip-coating, the substrate part was heated to a temperature of 70° C. for two hours to conduct the thermo-curing and solidifying of the coating (functional layer).

When using boehmite as a binder in the coating, it was possible to form layers with good adhesion to the substrate with both types of MOF particles, A520 and Mil-100.

Another substrate for forming functional layers including boehmite as binder was a zeolite wheel. The zeolite wheel had the same basic structure as the 3D printed polymeric wheel. Also on the zeolite wheel substrate, a functional layer could be formed having a good adhesion to the substrate, with both the S2 and the S4 coating compositions.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

### Example 4

Various Coating Compositions were Made Including MOFs, Binder, and Water.

Each coating composition contained 40 wt % aluminum hydroxide isophthalate (CAU-10) as MOF, with a D50 size of 4.98 microns, and a D90 size of 7.7 microns.

The different types of polymers used as a binder were grouped into Polymer 1 (water-insoluble polymers) and Polymer 2 (water-soluble polymers): As Polymer 1 were selected Rhoplex GL-618, a water-insoluble polymer self-crosslinking acrylic material, Maincote 5045, a styrene acrylic self-crosslinking water-insoluble polymer, and SILRES* MP 50E, a silicon binder with phenyl groups. The total amount of the Polymer I materials was between 3 and 6 wt % based on the total weight of coating composition.

Polymer 2 materials were selected CMC12M8P from Ashland, a water-soluble sodium carboxymethyl cellulose, and Lupasol PS, a water-soluble polyethyleneimine. The amount of the Polymer 2 materials was between 0.2 and 2 wt % for a total weight of the coating composition. The ratio between Polymer 1 and Polymer 2, based on dry content in the coating compositions, was between 2:1 and 10:1.

The coating compositions had a viscosity in a range of 0.5 to 50 cP at a shear rate of 10 s⁻¹, measured with an AR DH10 rheometer, using 40 mm 2-degree cone geometry.

Table 3 includes a summary of the samples and adhesion testing when applied on a stainless steel substrate via dip-coating.

TABLE 3

| | Polymer 1 | Polymer 2 | ALF [%] |
|---|---|---|---|
| S5 | Rhoplex GL618 | CMC | 0.67 |
| S6 | Maincote 5045 | CMC | 2.16 |
| C1 | Rhoplex GL 618 | PEI | 13.05 |
| C2 | Rhoplex GL618 + | — | to be measured |
| | Maincote 5045 | | |
| C3 | | CM + PEI | 25.6 |
| C4 | Rhoplex GL 618 | — | 7.98 |
| C5 | Maincote 5045 | — | to be measured |
| C6 | Silres* MP 50E | — | 14.68 |
| C7 | | CMC | 25.33 |

It was surprising and unexpected that certain combinations of polymers (i.e., Polymer 1 and Polymer 2) resulted in improved adhesion over other samples using one or a different combination of polymer materials.

Conducting of the Coating and Measurement of the Coating Adhesion

The functional layers on the samples were applied as coatings on 325 mesh stainless steel (T316L) substrate stripes via dip coating, using a gravity meter. The size of each substrate strip was 4 inches×1 inch, with a thickness of 86 microns. The target thickness of the coatings was between 100 μm to 200 μm. The coating line speed was between 2 FPM and 10 FPM and adopted to adjust to the desired coating weight. After the dip coating, the coatings were dried in an oven at 115° C. for 5 minutes. The weight of the substrate was measured before coating with the functional layer and the weight of the sample was measured after the coating process. The weight of the sample (substrate+coating) prior to adhesion testing was recorded as the starting weight.

The adhesion of the functional layer to the stainless steel substrate was tested according to a modified ASTM E8, using an Instron 5900 series instrument. The testing was conducted at a temperature of 25° C., at a relative humidity between 20% to 50% RH. Each sample was attached at each end to a 10 kN strong grip up to a distance of 1 inch of the end. After positioning of the sample in the grips, the grips were moved apart from each other at a pull rate of 5 mm/minute until failure. Failure was indicated by the Instron instrument by the sudden drop of the load of 80% or greater from the maximum load. A typical load curve until failure of the test stripe is shown in FIG. 5. After failure, the sample was removed from the grips and weighed. The weight after the test was recorded as the final weight.

The purpose of the adhesion testing was to evaluate the loss of the functional layer from the substrate. The strength of the adhesion of the coatings was quantified by the percent weight loss of the coating (i.e., adhesion loss factor (ALF)). The ALF was calculated as: ALF [%]=(final weight/starting weight)×100%. If portions of the coating were removed completely from the substrate, such loose portions were not included as part of the final weight.

The adhesion loss factor (ALF) values listed in Table 3 relate to functional layers formed on the above described stainless steel stripes.

### Example 5

Measuring the Water Absorption of MOF Containing Coatings.

Measurements were made comparing the water absorption of the MOF powder used as starting material for the coating compositions with the water absorption of the functional coating layers applied with coating composition S5 and of comparative coating composition C6.

The conducted test was a gravimetric water vapor sorption method via SMS DVS-Intrinsic as a function of the relative humidity at constant temperature of 25° C. For the testing, the test material (MOF powder or coated substrate) was placed in a chamber with controlled relative humidity. During the testing, the relative humidity was varied from 0% to 100%. After each change of the humidity value, it was waited until a constant weight of the sample was reached to quantify the maximum adsorption of water at a certain relative humidity.

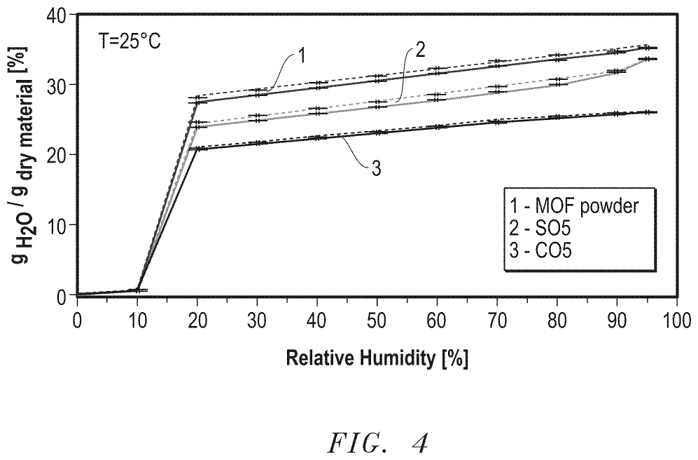

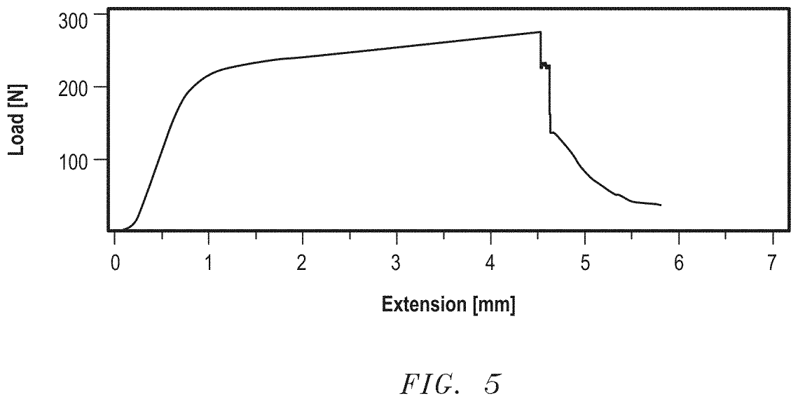

The test results are illustrated in the graph shown in FIG. 4. It can be seen that the water absorption of the functional coating made with coating composition S5 was very similar as the water absorption of the MOF powder. A plateau was reached already at about 20% RH, and the water absorption increased only minor until 100% RH. The difference in the water absorption of the MOF powder sample to the coating layer containing the MOF was only about 11%, expressed as normalized functionality ratio (NFR) of 0.89. The water absorption of the functional coating of comparative sample C6 was clearly lower than the water absorption of sample S5. Table 4 below summarizes the exact water absorption values at 30% RH and 80% RH.

The normalized functionality ratio of the water absorption of MOF powder to the representative functional layer of sample S5 was greater than 0.8.

TABLE 4

| | Water Absorption [g H₂O)/g dry | |
|---|---|---|
| | material | |
| Sample | 30% RH | 80% RH |
| MOF powder | 28 | 32 |
| S5 coating | 25 | 28 |
| C6 coating | 21 | 23 |
| NFR of water absorption MOF/S5 | 0.89 | 0.87 |
| NFR of water absorption MOF/C6 | 0.75 | 0.71 |

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

What is claimed is:

1. A body comprising:
a substrate; and
a functional layer overlying at least a portion of a surface of the substrate, wherein
the functional layer comprises metal organic frameworks (MOFs) and a binder, the binder including an organic polymer, and
an adhesion loss factor (ALF) of the functional layer to the substrate is not greater than 7%.

2. The body of claim 1, wherein the functional layer has a water absorption capacity of at least 15 g H₂O/g MOF at a temperature of 25° C. and a relative humidity at 80%.

3. The body claim 1, wherein a material of the substrate includes a metal, a metal alloy, a ceramic, or a polymer.

4. The body of claim 3, wherein the material of the substrate includes stainless steel.

5. The body of claim 1, wherein the functional layer is directly overlying an outer surface of the substrate.

6. The body of claim 1, wherein the organic polymer of the binder is an organic cross-linked polymer.

7. The body of claim 6, wherein the organic cross-linked polymer is a reaction product of a water-insoluble polymer and a water-soluble polymer.

8. The body of claim 7, wherein the water-soluble polymer includes a polysaccharide.

9. The body of claim 8, wherein the organic cross-linked polymer is a cross-linked polyacrylate, a cross-linked polyacrylate-polystyrene polymer, a cross-linked epoxide, a cross-linked polyurethane, or a cross-linked polyimide, or a cross-linked polyamide, or any combination thereof.

10. The body of claim 1, wherein an amount of the binder in the functional layer is at least 1 wt % and not greater than 30 wt % based on the total weight of the functional layer.

11. The body of claim 1, wherein an amount of the MOFs in the functional layer is at least 70 wt % based on the total weight of the functional layer.

12. The body of claim 1, wherein the binder is permeable to an analyte that can be adsorbed by the MOFs.

13. The body of claim 12, wherein the analyte includes at least one of water, CO₂, hydrogen, methane, ammonia, a water pollutant, or an air pollutant.

14. A coating composition comprising metal organic frameworks (MOFs), a binder, and a solvent, wherein the binder includes at least one first binder compound and at least one second binder compound, the at least one first binder compound being dissolved in the solvent and the at least one second binder compound not being dissolved in the solvent.

15. The coating composition of claim 14, wherein the solvent is water.

16. The coating composition of claim 14, wherein the at least one first binder compound includes a water-soluble polymer and the at least one second binder compound includes a water-insoluble polymer.

17. The coating composition of claim 14, wherein the at least one first binder compound includes a polysaccharide.

18. The coating composition of claim 17, wherein the polysaccharide is carboxymethyl cellulose.

19. A filter comprising the body of claim 1, wherein the filter is adapted for adsorbing an analyte.

20. The filter of claim 19, wherein the filter is a dehumidifier.
